(19) United States
(12) Patent Application Publication
(10) Pub. No.: US 2013/0153383 A1
(43) Pub. Date: Jun. 20, 2013

(54) PUSH BUTTON ASSEMBLY

(71) Applicants: WEI-KUANG LIANG, Tu-Cheng (TW); QUAN-GUANG DU, Shenzhen City (CN); CHUN-YANG ZHAO, Shenzhen City (CN)

(72) Inventors: WEI-KUANG LIANG, Tu-Cheng (TW); QUAN-GUANG DU, Shenzhen City (CN); CHUN-YANG ZHAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,365

(22) Filed: Aug. 29, 2012

(30) Foreign Application Priority Data
Dec. 16, 2011 (CN) 201110423253.6

(51) Int. Cl. H01H 3/12

(52) U.S. Cl. 200/345

(57) ABSTRACT

A push button assembly includes a female member comprising a base and a socket integral with the base, a male member movably mounted to the female member, and a resilient member. The male member includes a pressing portion and a positioning portion extending downwards from a lower surface side of the pressing portion. The positioning portion is captive in the socket. The male member is movable between a first position and second position. The resilient member surrounds the positioning portion. When a push force is applied to the pressing portion of the male member, the resilient member is deformed and the male member is moved to the second position. When the push force is released, the resilient member recovers and drives the male member to move to the first position, but the resilient member is always constrained to undergo compression and release along its own central axis.

### REFERENCE TO RELATED APPLICATIONS

This application claims all benefits accruing under 35 U.S.C. §119 from China Patent Application No. 201110423253.6, filed on Dec. 16, 2011 in the State Intellectual Property Office of China, the contents of the China Application are hereby incorporated by reference.

### BACKGROUND

1. Technical Field

The present disclosure generally relates to switches, and particularly relates to push button assemblies.

2. Description of Related Art

Many electronic devices, such as computers, mobile phones, television sets, and gaming devices, have push buttons which can be operated by pressing the push buttons to switch on electronic circuits or to carry out certain functions. A known push button assembly includes a female member, a male member coupled to the female member, and a resilient member arranged between the female and male members. When a push force is applied to a top surface of the male member, the male member moves towards the female member and deforms the resilient member. When the push force is released, the resilient member recovers and drives the male member to move back to an original position. However, the resilient member is often biased or curved away from a central axis after being pressed numerous times, resulting in a gradual degradation of performances of the push button assembly.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a push button assembly in accordance with an embodiment.

FIG. 2 is an isometric view of a female member of FIG. 1.

FIG. 3 is a cutaway view of the female member of FIG. 2.

FIG. 4 is an assembled view of the push button assembly of FIG. 1.

FIG. 5 is a cross-sectional view of the push button assembly of FIG. 4 taken along a line V-V.

FIG. 6 is similar to FIG. 5, showing a male member in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

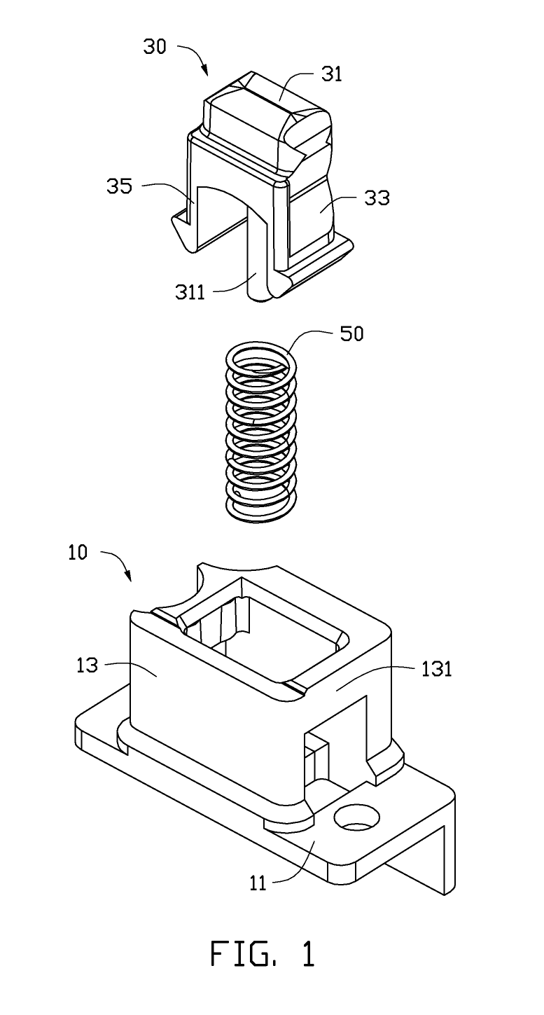

FIG. 1 illustrates a push button assembly in accordance with an embodiment. The push button assembly includes a female member 10, a male member 30, and a resilient member 50. In some embodiments, the resilient member 50 is a compression spring.

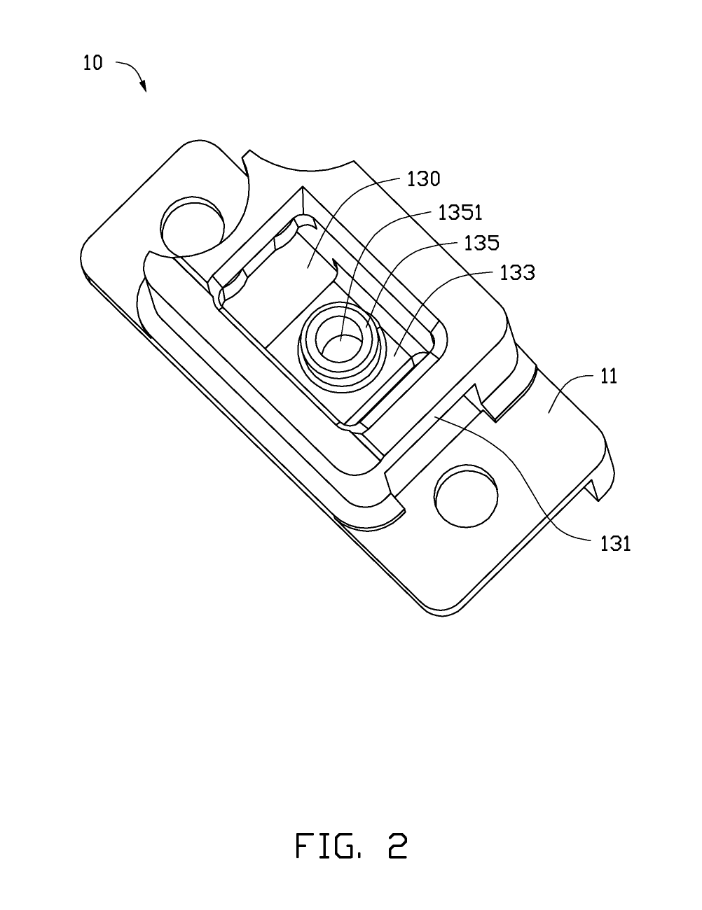

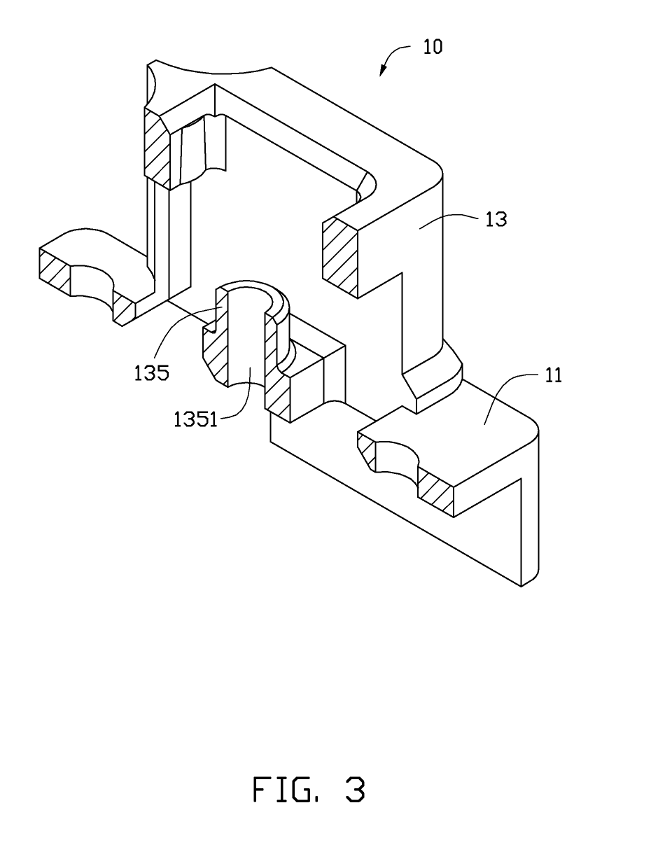

The female member 10 includes a base 11 and a socket 13 integral with the base 11. Referring to FIGS. 2 and 3, the socket 13 defines a receiving space 130. Two blocking portions 131 are formed on two opposite sidewalls of the socket 13. A supporting portion 133 is nested in the socket 13. A limiting portion 135 protrudes from a top surface of the supporting portion 133. The limiting portion 135 defines a limiting bore 1351. In some embodiments, the limiting portion 135 is a hollow cylinder and the limiting bore 1351 is the interior surface of the hollow cylinder.

Referring to FIG. 1, the male member 30 includes a pressing portion 31, a first hook 33, and a second hook 35. The first hook 33 and the second hook 35 extend downwardly from two opposite sides of the pressing portion 31. The first hook 33 and the second hook 35 are both perpendicular to the pressing portion 31. A positioning portion 311 extends downwardly from a lower surface of the pressing portion 31. The positioning portion 311 is located between the first hook 33 and the second hook 35. In some embodiments, the positioning portion 311 is a cylindrical post and is perpendicular to the pressing portion 31.

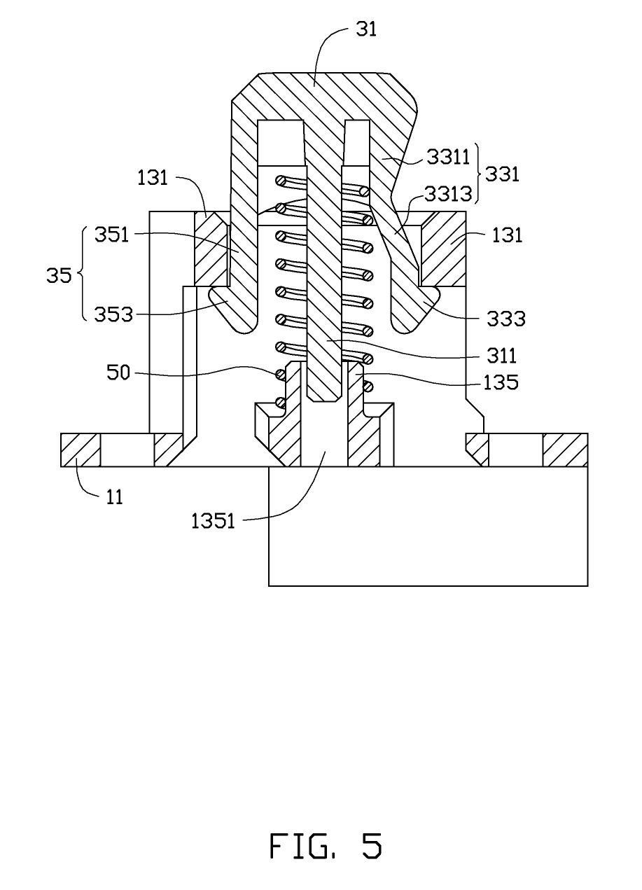

Referring to FIG. 5, the first hook 33 includes a first elastic portion 331 and a first hooking portion 333. The first elastic portion 331 includes a first arm 3311 and a second arm 3313. The first arm 3311 is integral with the pressing portion 31 and the second arm 3313 is slanted outwards from an end of the first arm 3311. The first hooking portion 333 extends from an end of the second arm 3313. In some embodiments, an angle between the first arm 3311 and the second arm 3313 is greater than 90 degrees.

The second hook 35 includes a second elastic portion 351 and a second hooking portion 353. The second elastic portion 351 is integral with the pressing portion 31 and the second hooking portion 353 extends from an end of the second elastic portion 351. The first hooking portion 333 of the first hook 33 and the second hooking portion 353 of the second hook 35 extend in opposite directions.

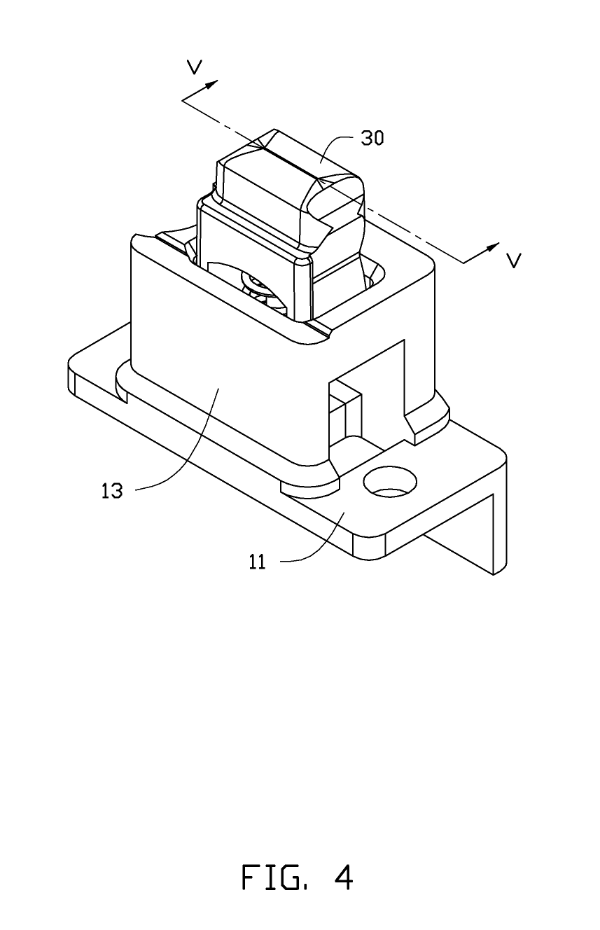

Referring to FIG. 4, in assembly, the positioning portion 311 of the male member 30 is sleeved with the resilient member 50. The male member 30 is moved towards the female member 10 and the positioning portion 311 of the male member 30 is aligned with the limiting bore 1351 of the female member. The first hook 33 and the second hook 35 of the male member 30 are deformed to be closer to each other and are inserted into the socket 13 of the female member 10. The first hook 33 and the second hook 35 are moved down, until the first hooking portion 333 of the first hook 33 and the second hooking portion 353 of the second hook 35 are engaged with each of the two blocking portions 131 of the socket 13 respectively. The positioning portion 311 of the male member 30 is moved down until a free end of the positioning portion 311 is received in the limiting bore 1351 of the female member 10. The resilient member 50 surrounds the limiting portion 135. One end of the resilient member 50 abuts the lower surface of the pressing portion 31 of the male member 30, and the other end of the resilient member 50 abuts the top surface of the supporting portion 133 of the female member 10. Thus, the male member 30 is coupled to the female member 10 and the male member 30 is located in a first position as shown in FIG. 5. In some embodiments, a central axis of the positioning portion 311 of the male member 30 substantially overlaps with a central axis of the limiting bore 1351 of the female member 10.

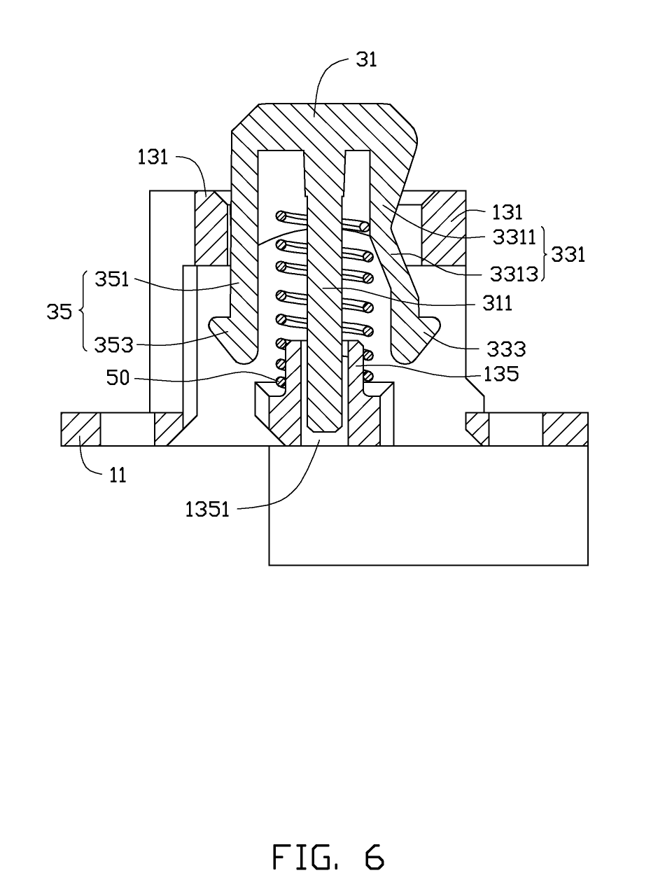

Referring to FIG. 6, when a push force is applied to the top surface of the pressing portion 31 of the male member 30, the male member 30 is moved down. The first hooking portion 333 of the first hook 33 and the second hooking portion 353 of the second hook 35 drop below the two blocking portions 131 of the socket 13 of the female member 10. The resilient member 50 is deformed by the downward movement of the pressing portion 31 of the male member 30. The positioning portion 311 of the male member 30 is moved downwards in the limiting bore 1351 of the female member 10. Thus, the male member 30 is located in a second position as shown in FIG. 6. When the push force is released, the resilient member 50 restores to drive the pressing portion 31 the male member 30 to move upwardly. Accordingly, the positioning portion 311 of the male member 30 rises up again in the limiting bore 1351 of the female member 10. The first hooking portion 333 of the first hook 33 and the second hooking portion 353 of the second hook 35 again engage and bind on the two blocking portions 131 of the socket 13 of the female member 10.

Since the resilient member 50 surrounds the positioning portion 311 of the male member 30 and one end of the resilient member 50 is tied to the limiting portion 135 of the female member 10, the resilient member 50 will not be biased and bend away from its uncompressed central axis. Therefore, the resilient member 50 maintains a good performance for a significantly longer time notwithstanding millions of pressing operations.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A push button assembly comprising:
a female member comprising a base and a socket integrally formed with the base;
a male member movably mounted to the female member, wherein the male member comprises a pressing portion and a positioning portion extending downwardly from a lower surface side of the pressing portion, the positioning portion is plugged in the socket, and the male member is movable between a first position and second position; and
a resilient member surrounding the positioning portion, wherein when a push force is applied to the pressing portion of the male member, the resilient member is deformed and the male member is moved to the second position; when the push force is released, the resilient member recovers and drives the male member to move to the first position.

2. The push button assembly of claim 1, wherein the female member further comprises a supporting portion nested in the socket, and a first end of the resilient member abuts a top surface of the supporting portion.

3. The push button assembly of claim 2, wherein the female member further comprises a limiting portion protruding from the top surface of the supporting portion, and the first end of the resilient member surrounds the limiting portion.

4. The push button assembly of claim 3, wherein the limiting portion defines a limiting bore, and a free end of the positioning portion is received in the limiting bore.

5. The push button assembly of claim 4, wherein the limiting portion is a hollow cylinder and the limiting bore is a cylindrical bore.

6. The push button assembly of claim 5, wherein the positioning portion is a cylindrical post.

7. The push button assembly of claim 6, wherein a central axis of the positioning portion substantially overlaps a central axis of the limiting bore.

8. The push button assembly of claim 4, wherein the free end of the positioning portion remains received in the limiting bore when the male member is located either in the first position or in the second position.

9. The push button assembly of claim 1, wherein the male member comprises two hooks extending downwardly from a lower side surface of the pressing portion, the female member comprises two blocking portions formed with two opposite sidewalls of the socket, and each of the two hooks is engaged with each of the two blocking portions thereby coupling the male member to the female member.

10. A push button assembly comprising:
a female member comprising a base and a socket integrally formed with the base;
a male member movably mounted to the female member, wherein the male member comprises a pressing portion and a positioning portion extending downwardly from a lower surface side of the pressing portion, and the positioning portion is plugged in the socket; and
a resilient member surrounding the positioning portion.

11. The push button assembly of claim 10, wherein the male member comprises a first hook and a second hook, the first hook and the second hook extend downwardly from two opposite sides of the pressing portion, the female member comprises two blocking portions formed with two opposite sidewalls of the socket, each of the first hook and the second hook is engaged with each of the two blocking portions thereby preventing the male member from disengaging from the female member.

12. The push button assembly of claim 11, wherein the female member further comprises a supporting portion nested in the socket, and a first end of the resilient member abuts a top surface of the supporting portion.

13. The push button assembly of claim 12, wherein the female member further comprises a limiting portion protruding from the top surface of the supporting portion, and the first end of the resilient member surrounds the limiting portion.

14. The push button assembly of claim 13, wherein the limiting portion defines a limiting bore, and a free end of the positioning portion is received in the limiting bore.

15. The push button assembly of claim 14, wherein the limiting portion is a hollow cylinder and the limiting bore is a cylindrical bore.

16. The push button assembly of claim 15, wherein the positioning portion is a cylindrical post.

17. The push button assembly of claim 16, wherein a central axis of the positioning portion substantially overlaps a central axis of the limiting bore.

18. The push button assembly of claim 14, wherein when a push force is applied to the pressing portion of the male member, the resilient member is deformed and the male member is moved to a second position; when the push force is released, the resilient member recovers and drives the male member to move to a first position.

19. The push button assembly of claim 18, wherein the free end of the positioning portion remains received in the limiting bore when the male member is located either in the first position or in the second position.

20. The push button assembly of claim 11, wherein the first hook comprises a first arm and a second arm slanted outwards from an end of the first arm, and an angle between the first arm and the second arm is greater than 90 degrees.
